(19) United States
(12) Patent Application Publication
(10) Pub. No.: US 2025/0000726 A1
(43) Pub. Date: Jan. 2, 2025

(54) STRETCHER HAVING MODULAR FRAMES, SIDERAILS, AND NESTING RECHARGING

(71) Applicant: HILL-ROM SERVICES, INC., Batesville, IN (US)

(72) Inventors: Nicholas Mann, Cincinnati, OH (US); David C. Newkirk, Lawrenceburg, IN (US); Todd O'Neal, Batesville, IN (US); Travis A. Pelo, Batesville, IN (US); Frank Sauser, Batesville, IN (US); Jack B. Sing, Batesville, IN (US); Neal Wiggermann, Batesville, IN (US); Robert Mark Zerhusen, Batesville, IN (US)

(21) Appl. No.: 18/757,650

(22) Filed: Jun. 28, 2024

Related U.S. Application Data
(60) Provisional application No. 63/510,722, filed on Jun. 28, 2023.

(51) Int. Cl. A61G 1/04; A61G 1/02

(52) U.S. Cl. CPC A61G 1/04; A61G 1/02

(57) ABSTRACT

A system and method for control of the charging of a system of patient support apparatuses positioned adjacent one another from a single one of the patient support apparatuses.

### PRIORITY CLAIM

This application claims priority under 35 U.S.C. § 119 (e) to U.S. Provisional Application No. 63/510,722, filed Jun. 28, 2023, which is expressly incorporated by reference herein in its entirety.

### BACKGROUND

The present disclosure is directed to a patient support apparatus having modular construction that is adaptable to different levels of acuity and a control system operable to control the charging of batteries of the patient support apparatus along with adjacent patient support apparatuses.

Due to the varying needs and a patient care facility, current stretcher patient platforms are difficult to manage and store. It is common in emergency departments to see stretchers lined up head to foot taking up valuable space. Additionally, electrically powered stretchers require power for charging their battery backups even when they are stored. The challenge of finding extension cords or outlets for these stretchers can be an inefficient use of a caregiver's time especially in times of surges in patient populations. While the use of rechargeable batteries in patient support apparatus as is known, there is a challenge in having the availability of fully charged batteries which are often positioned in a location separate from where the stretchers are stored.

Additionally, the need to have stretchers which are adapted for particular use environments creates cost concerns for facilities as they attempt to identify the appropriate configuration of stretcher that is most flexible to their various use cases. While traditionally stretchers have been manually powered, given the aging caregiver population and the need for increased caregiver efficiency, a need for adaptable powered stretchers is developing in the market. However a competing consideration is the need to maintain reasonable costs for stretchers which are often dispersed throughout a facility and inventories are difficult to control. These competing interests are driving a need for a module early adaptable stretcher that provides power at a reasonable cost. Because the powered stretchers are often moved around a facility and not always adjacent a power outlet, there also exists a need to manage the charging of the stretcher's so that they are ready to use at a moment's notice.

### SUMMARY

The present disclosure includes one or more of the features recited in the appended claims and/or the following features which, alone or in any combination, may comprise patentable subject matter.

According to a first aspect of the present disclosure, a patient support apparatus comprises a lower frame, a lift system, an upper frame supported on the lift system and movable relative to the lower frame through operation of the lift system, and a modular side rail. The modular siderail includes a side rail mechanism secured to the upper frame and a barrier portion supported on the side rail mechanism. The side rail mechanism provides movement of the barrier portion relative to the upper frame between a lowered and a raised position. The barrier portion includes a barrier frame having a rail defining an interior space, the interior space configured to receive at least one insert selected from a kit of inserts having different configurations.

In some embodiments of the first aspect, the at least one insert includes a panel formed to include a cavity sized to receive at least one user interface module selected from a kit of user interface modules having different configurations. In some embodiments, the at least one user interface module includes a standalone nurse call module. In some embodiments of the first aspect, the at least one user interface module includes a standalone sensor interface module. In some embodiments, the at least one user interface module includes a standalone bed control module. In some embodiments of the first aspect, the at least one user interface module includes a GUI pod.

In some embodiments of the first aspect, the at least one insert includes a translucent portion. In some embodiments, the at least one insert includes an opaque portion.

In some embodiments of the first aspect, the at least one insert comprises a fixed user interface positioned on a first side of the panel, the cavity being sized to receive at least one user interface module is positioned on a second side opposite of the first side of the panel.

In some embodiments of the first aspect, the at least one insert comprises a first cavity positioned on a first side of the panel, and wherein the insert comprises a second cavity on a second side of the panel, the first cavity positioned on the first side of the panel configured to receive a removable GUI pod.

In some embodiments of the first aspect, the second cavity on the second side of the panel is configured to receive a user interface module that includes a standalone nurse call module. In some embodiments, the second cavity on the second side of the panel is configured to receive a user interface module that includes a standalone sensor interface module. In some embodiments, the second cavity on the second side of the panel is configured to receive a user interface module that includes standalone bed control module. In some embodiments, the lower frame includes a main portion configured to receive at least one castor module selected from a kit of differing castor modules having different operational characteristics.

In some embodiments of the first aspect, the at least one castor module includes a pair of independently powered casters. In some embodiments, the at least one castor module includes a first castor module configured to be positioned at a head end of the main portion and a second castor module configured to be positioned at a foot end of the main portion, the first castor module being configured to nest within the second castor module. In some embodiments, the first castor module in the second castor module are configured to transfer power therebetween using an inductive coupling, when the first castor module is nested with the second castor module.

In some embodiments of the first aspect, the main portion of the lower frame is configured to support a powered wheel module within the main portion, the powered wheel module operable to drive the patient support apparatus over the floor.

In some embodiments of the first aspect, the lower frame comprises a main portion; the lift system comprises a pair of lift columns, each of the pair of lift columns positionable in at least two different positions within the main portion. In some embodiments, the pair of lift columns are positionable adjacent one another, nearer a head end of the main portion. In some embodiments, each of the lift columns of the pair of lift columns are positionable spaced apart from the other of the lift columns, a first one of the pair of lift columns positionable near a head end of the main portion and the second one of the pair of lift columns positionable near a foot end of the main portion.

In some embodiments of the first aspect, the patient support apparatus further comprises a first power module positionable in at least two different positions within the main portion of the lower frame. In some embodiments, the patient support apparatus further comprises a second power module positionable in at least two different positions within the main portion of the lower frame. In some embodiments, at least one of the first or second power modules includes a removable battery. In some embodiments, the first power module includes at least one removable battery. In some embodiments, the first power module includes two removable batteries.

In some embodiments of the first aspect, the patient support apparatus further comprises a control module positionable in at least two different positions within the main portion of the lower frame. In some embodiments, the control module includes a controller having a processor and a memory device, communications circuitry, and power transfer circuitry, the memory device including instructions that when executed by the processor cause the controller to communicate with the lift columns and the at least one power module to control operation of the lift columns and the at least one power module. In some embodiments, the communications circuitry of the control module communicates wirelessly with the lift columns and the at least one power module.

In some embodiments of the first aspect, the patient support apparatus further comprises at least one user interface module, the control module in wireless communication with the user interface module to receive inputs from a user and to wirelessly control operation of the lift columns in at least one power module based on inputs wirelessly received from the user interface module.

According to a second aspect of the present disclosure, a side rail assembly for a patient support apparatus comprises a side rail mechanism and a barrier portion. The side rail mechanism is configured to be secured to a patient support apparatus and operable to move between a lowered position in a raised position. The side rail mechanism lockable in the raised position. The barrier portion is supportable on the side rail mechanism. The barrier portion includes a barrier frame. The barrier frame includes a rail defining an interior opening configured to receive and support at least one insert. The at least one insert is selected from a kit of inserts having different configurations.

In some embodiments of the second aspect, the at least one insert includes a panel formed to include a cavity sized to receive at least one user interface module selected from a kit of user interface modules having different configurations. In some embodiments, the at least one user interface module includes a standalone nurse call module. In some embodiments, the at least one user interface module includes a standalone sensor interface module. In some embodiments, the at least one user interface module includes a standalone bed control module. In some embodiments, the at least one user interface module includes a GUI pod.

In some embodiments of the second aspect, the at least one insert includes a translucent portion. In some embodiments, the at least one insert includes an opaque portion.

In some embodiments of the second aspect, the at least one insert comprises a fixed user interface positioned on a first side of the panel, and wherein the cavity sized to receive at least one user interface module is positioned on a second side opposite of the first side of the panel.

In some embodiments of the second aspect, the at least one insert comprises a first cavity positioned on a first side of the panel and the insert comprises a second cavity on a second side of the panel, the first cavity positioned on the first side of the panel configured to receive a removable GUI pod. In some embodiments, the second cavity on the second side of the panel is configured to receive a user interface module that includes a standalone nurse call module. In some embodiments, the second cavity on the second side of the panel is configured to receive a user interface module that includes a standalone sensor interface module. In some embodiments, the second cavity on the second side of the panel is configured to receive a user interface module that includes standalone bed control module.

According to a third aspect of the present disclosure, a patient support apparatus comprises a lower frame, a power module, a control system, and a user interface. The lower frame includes a main portion, a first castor module positioned at a head end of the main portion, and a second castor module positioned at a foot end of the main portion. The power module is positionable in multiple positions on the main portion, the power module including a rechargeable battery. The control system includes a controller having a processor and a memory, the memory including instructions executable by the processor. The user interface including a touchscreen and the user interface is operable to display information regarding the charge in the rechargeable battery of the power module, and to receive inputs from a user. The controller is operable to receive information regarding the charge in a patient support apparatus adjacent the patient support apparatus of the controller, display information regarding the charge of batteries of the adjacent patient support apparatus, and to, based on inputs from a user, transfer a charge from the power module of the patient support apparatus to the batteries of an adjacent patient support apparatus.

In some embodiments of the third aspect, the first castor module of the patient support apparatus is configured to nest with a second castor module of an adjacent patient support apparatus. In some embodiments, the first castor module of the patient support apparatus includes an inductive coupler operable to transfer power between an inductive coupler with the second castor module of the adjacent patient support apparatus under the control of the controller.

In some embodiments of the third aspect, the patient support apparatus includes a plurality of power modules positioned on the main portion of the lower frame.

In some embodiments of the third aspect, the controller of the patient support apparatus is operable to detect a plurality of adjacent patient support apparatuses, communicate with the adjacent patient support apparatuses to determine a level of charge in their respective power modules, and to display the respective charges of each of the patient support apparatuses power modules on the user interface.

In some embodiments of the third aspect, the controller of the patient support apparatus is operable to transfer power between the adjacent patient support apparatuses to charge the respective power modules of each of the adjacent patient support apparatuses.

In some embodiments of the third aspect, the controller of the patient support apparatus is operable to transfer power between the adjacent patient support apparatuses when at least one of the patient support apparatuses is connected to an outlet. In some embodiments, the controller of the patient support apparatus is operable to transfer power between the adjacent patient support apparatuses when none of the adjacent patient support apparatuses is connected to an outlet.

In some embodiments of the third aspect, the controller communicates wirelessly between the user interface and the power module.

In some embodiments of the third aspect, the controller and the user interface are powered inductively by the power module.

In some embodiments of the third aspect, the patient support apparatus further comprises a lift column supported on the lower frame and an upper frame supported on the lift column, the lift column operable to move the upper frame relative to the lower frame, the lift column being powered inductively by the power module.

In some embodiments of the third aspect, the controller communicates wirelessly with the lift column, the controller receiving inputs from the user interface and controlling operation of the lift column based on the inputs from the user interface.

According to a fourth aspect of the present disclosure, a method of charging a system of patient support apparatuses includes positioning a first and a second patient support apparatus adjacent one another; establishing communication between the first and second patient support apparatus; detecting the respective charge levels of the adjacent patient support apparatuses; and utilizing a control system of the first patient support apparatus to control the operation of power modules on each the first and second patient support apparatuses to transfer a charge between the power modules of each of the first and second patient support apparatuses to achieve an acceptable charge level in each of the first and second patient support apparatuses.

In some embodiments of the fourth aspect, the method further comprises connecting at least one of the first and second patient support apparatuses to an outlet to receive power from the outlet, the power from the outlet being used to charge both the first and second patient support apparatuses.

In some embodiments of the fourth aspect, the method further comprises transferring the charge between the power modules of the first and second patient support apparatuses when the first and second apparatuses are not connected to an external source of power.

In some embodiments of the fourth aspect, the method further comprises positioning a third patient support apparatus adjacent at least one of the first and second patient support apparatuses, and wherein the detecting the respective charge levels of the adjacent patient support apparatuses includes detecting the respective charge levels of the first, second, and third patient support apparatuses.

In some embodiments of the fourth aspect, the method further comprises transferring a charge between the power modules of each of the first, second, and third patient support apparatuses to achieve an acceptable charge level in each of the first, second, and third patient support apparatuses.

In some embodiments of the fourth aspect, the method further comprises connecting at least one of the first, second, and third patient support apparatuses to an outlet to receive power from the outlet, the power from the outlet being used to charge the first, second, and third patient support apparatuses.

In some embodiments of the fourth aspect, the method further comprises transferring the charge between the power modules of the first, second, and third patient support apparatuses when the first, second, and third apparatuses are not connected to an external source of power.

Additional features, which alone or in combination with any other feature(s), such as those listed above and/or those listed in the claims, can comprise patentable subject matter and will become apparent to those skilled in the art upon consideration of the following detailed description of various embodiments exemplifying the best mode of carrying out the embodiments as presently perceived.

### BRIEF DESCRIPTION OF THE DRAWINGS

The detailed description particularly refers to the accompanying figures in which:

FIG. 1 is a perspective view of a patient support apparatus embodied as a stretcher of the present disclosure, the view of FIG. 1 taken from a patient's left side near the foot end of the stretcher;

FIG. 2 is a side view of another embodiment of a stretcher having a different side rail configuration;

FIG. 3 is a side view of the stretcher of FIG. 1;

FIG. 4 is a side view of yet another embodiment of a stretcher having yet a different side rail configuration;

FIG. 5 is a side view of still yet another embodiment of a stretcher having still yet a different side rail configuration;

FIG. 6 is a side view of yet still another embodiment of a stretcher having yet still another side rail configuration;

FIG. 7 is a side view of yet another embodiment of a stretcher having a different lift column configuration;

FIG. 8 is a perspective view of a system of optional side rail components according to the present disclosure, the components shown allowing a user to configure a particular side rail in a multitude of ways to adapt the stretcher for particular use;

FIG. 9 is a perspective view of a side rail for a stretcher, FIG. 9 illustrating a kit of user interface modules which may be utilized on the side rail;

FIG. 10 is a perspective view of a side rail similar to the side rail of FIG. 9, with the side rail of FIG. 10 including specific user interface modules;

FIG. 11 is a perspective view of a side rail similar to the side rail of FIG. 9, with the side rail of FIG. 11 including specific user interface modules;

FIG. 12 is a perspective view of a system of optional stretcher components according to the present disclosure, the components shown allowing a user to configure a particular stretcher in a multitude of ways to adapt the stretcher for particular use;

FIG. 13 is a perspective view of a portion of a stretcher showing the arrangement of modular components in a lower frame of the stretcher;

FIG. 14 is a perspective view similar to FIG. 13, but enlarged to show the remove ability of a battery from a power module of the stretcher;

FIG. 15 is a perspective view of a bottom of a lower frame of the stretcher showing extendable legs that are used to support the stretcher during procedures to provide stability;

FIG. 16 is a perspective view of the lower frames of two adjacent stretchers nested together for storage and to allow the transfer of power between the adjacent stretchers;

FIG. 17 is a perspective view of the adjacent stretchers of FIG. 16 further showing the arrangement of the upper frame of the adjacent stretchers to facilitate nesting;

FIG. 18 is a side view of three stretchers nested together for storage and to share power there between;

FIG. 19 is an image presented on a touchscreen of the user interface for controlling the management of power between the adjacent stretchers of FIG. 18; and

FIG. 20 is a block diagram of an embodiment of a control system for the stretchers disclosed herein.

### DETAILED DESCRIPTION

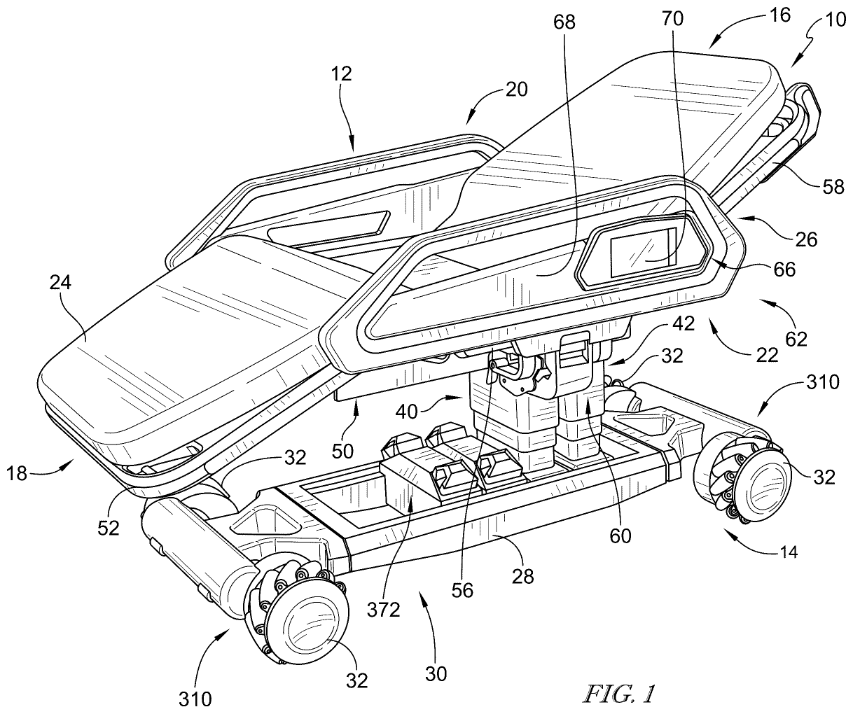

Referring now to FIG. 1, a patient support apparatus 10, embodied as a stretcher 10, is described herein with respect to a patient lying supine on the stretcher 10 so that a right side of the patient is adjacent a right side 12 of the stretcher 10, and a left side of the patient is adjacent a left side 14 of the stretcher 10. Additionally, a head of the patient is positioned adjacent a head end 16 of the stretcher 10, and feet of the patient are positioned adjacent a foot end 18 of the stretcher 10. The stretcher 10 includes a right-hand side rail 20 and the left-hand side rail 22 which are supported from an upper frame 50. A patient supporting surface 24 is positioned on an articulated deck 26.

The stretcher 10 includes a lower frame 30 having a main portion 28 and a plurality of casters 32 that enable the stretcher to be moved throughout a healthcare facility. In some embodiments, the casters 32 include locks or brakes (not shown) to limit movement of the stretcher 10 across a floor. In the disclosed embodiment, casters 32 include one or more motorized wheels as shown and described in U.S. application Ser. No. 18/177,837, filed Mar. 3, 2023, and titled PATIENT SUPPORT APPARATUS HAVING MOTORIZED WHEELS (see particularly, FIGS. 25A-28F and the related discussion of non-swivelable mecanum wheels) which is hereby incorporated herein by reference in its entirety for the disclosure of an applicable caster arrangement and to the extent not inconsistent with the present disclosure which shall control as to any inconsistency.

A pair of lift columns 40, 42 extend upward from the lower frame 30 and is operable to raise and lower an upper frame 50 vertically relative to the floor. In the illustrated embodiment, the column 40 includes a plurality of telescoping sections that enable the column to extend and retract to raise and lower the upper frame 50 coupled the columns 40, 42. The lift columns 40, 42 are powered by a hydraulic system such as that disclosed in U.S. Patent Publication No. 2005/0198737A1, published on Sep. 15, 2005 and titled HYDRAULIC LIFT APPARATUS FOR A PATIENT SUPPORT,” which is incorporated herein by reference for the disclosure of an applicable hydraulic lift system.

The articulated deck 26 includes a foot deck section 52, a thigh deck section 54, a seat section 56, and a head deck section 58. The head deck section 58 is pivotably coupled to the seat section 56 and moves between a lowered position when the deck 26 is in a flat configuration in a fully raised position, as is known in the art. The seat section 56 is supported on the upper frame 50. The thigh deck section 54 is pivotably coupled to the seat section 56 and moves from a flat position to a raised position, such as that shown in FIG. 1. The foot deck section 52 is pivotally coupled to the thigh deck section 54 and pivots downwardly therefrom as shown in FIG. 1 so that a patient's legs are supported with a knee break at the point of inflection between the thigh deck section 54 and the foot deck section 52.

The side rail 22 is one embodiment of the present disclosure which includes the concept of modular siderails that allows the stretcher 10 to be configured using different rail variance from a set of common parts to meet different user and clinical needs. The side rail 22 includes a side rail mechanism 60 which supports a barrier assembly 62 and moves the barrier assembly 62 relative to the upper frame 50 between a lowered position and a locked raised position as is known in the art. In the present disclosure, the side rail mechanism 60 is used across multiple embodiments with the barrier assembly 62 being configurable in a number of different embodiments to achieve a particular arrangement useful in particular care environments or acuity levels. In the embodiment of FIG. 1, the barrier assembly 62 includes a barrier frame 64, which supports a removable GUI pod 66 supported on a removable GUI pod insert 68. The relationship between the GUI pod 66 and the removable GUI pod insert 68 will be discussed in further detail below. The GUI pod 66 includes a touchscreen 70 which provides a menu-driven GUI that provides a user, such as a caregiver, easy access to various controls of the stretcher 10 as well as access to additional information as is known in the art. The GUI pod 66 is removable from the side rail 22 and may be used as a handheld device similar to a smart phone or tablet computer. In such a situation, the GUI pod 66 would be paired with a specific stretcher 10 and operable to communicate wirelessly with a control system of the stretcher 10. The discussion herein will focus on the structure of various embodiments of a left-hand side rail 22, but it should be understood that the right-hand side rail 20 could have any of the variations discussed herein, albeit the structures will be a mirror image of the structures described with regard to left-hand side rail 22.

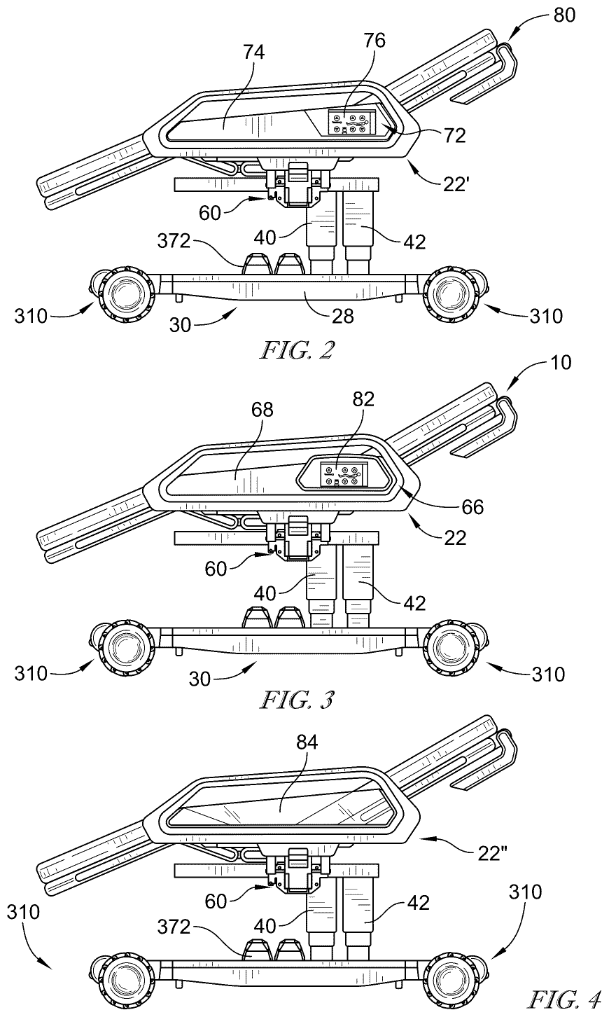

Referring now to FIGS. 2-4, multiple embodiments of siderails are shown, with each utilizing the side rail mechanism 60. As shown in FIG. 2, a stretcher 80 is similar to the embodiment of stretcher 10 shown in FIG. 1, but the removable GUI pod 66 is omitted and replaced with a fixed GUI 72 that is supported in a fixed GUI insert 74 of a side rail 22′. In the embodiment of FIG. 2, the GUI 72 includes a touchscreen 76, but the fixed GUI 72 is not removable. In some embodiments, the fixed GUI 72 may have the touchscreen omitted and may include traditional fixed user inputs that comprise specific buttons or switches for dedicated functions as is known in the art.

Referring to FIG. 3, a stretcher 90 includes a side rail 22″ which includes a removable GUI pod 66. However, in the embodiment of FIG. 3, the GUI pod 66 includes a user interface 82 which includes discrete buttons that are dedicated to specific functions of the stretcher 90. The removable GUI pod 66 may be connected to the control system of the stretcher 90 through a wired or a wireless connection. In this way the GUI pod 66 is removable from the side rail 22″ to be used by a caregiver in a detached relationship. The removable GUI pod 66 may be connected to the control system of the stretcher 90 similarly to a pendant as is known in the art.

In yet another embodiment shown in FIG. 4, a stretcher 100 includes a side rail 22′″ the does not include a GUI or other user interface, but rather includes an opaque insert 84 that is positioned in the barrier frame 64. In the embodiment of FIG. 4, the insert 84 provides an aesthetically pleasing version of a simple side rail, while allowing the side rail 22′″ to share common components with the other embodiments of siderails discussed above. In addition, as we discussed in further detail below, the insert 84 is removable and interchangeable with the fixed GUI insert 74 and the removable GUI pod insert 68 so that any given stretcher may be reconfigured by simply replacing a few components of the respective side rail. In some embodiments, the opaque insert 84 is translucent or transparent. In some embodiments the insert comprises an acrylic material. It is contemplated that in some embodiments, the insert 84 may comprise a glass material. It should be understood that the insert 84 may be customized in various colors or textures to vary the aesthetic appearance of the side rail when the insert 84 is present. The variances described with regard to the insert 84 herein, may also be applied to the removable GUI pod insert 68 or the fixed GUI insert 74. In other words, each of the inserts 68, 74, 84 may be customized using various materials and colors to provide aesthetic variations to a particular stretcher.

In a variation of the approach to utilizing siderails on a stretcher described above, in the embodiments of FIGS. 5-8, the side rails 122, 122, 122 utilize a different mechanism 160 to support the barrier structure 162. In the embodiment of FIG. 5, the stretcher 110 includes a side rail 122 that has a barrier frame 64 supported on the mechanism 160. The side rail 122 includes a removable GUI pod insert 68 which supports the GUI pod 66 described above.

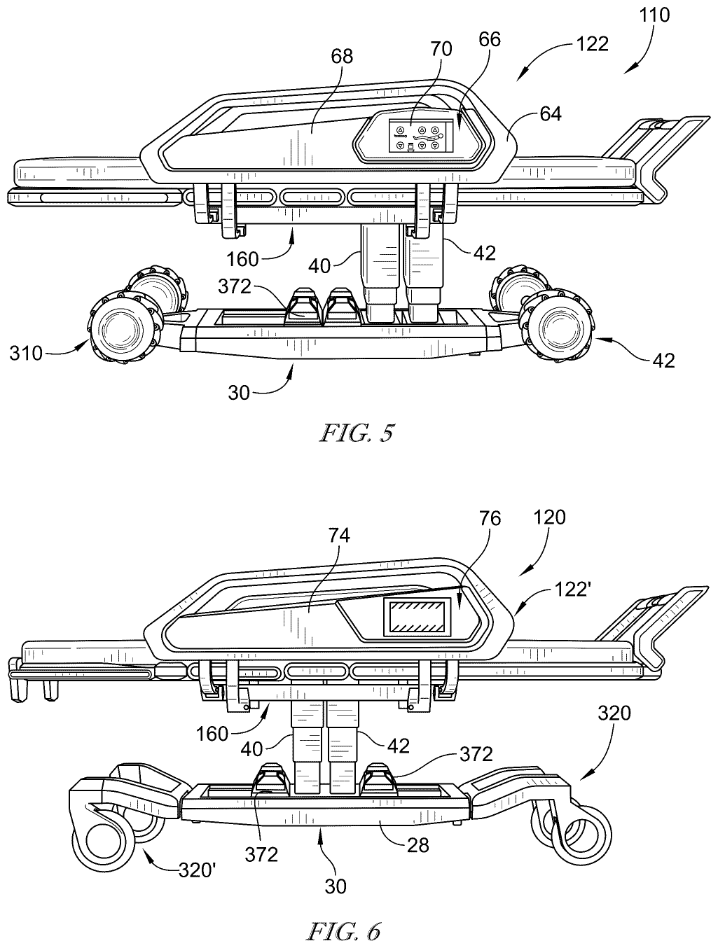

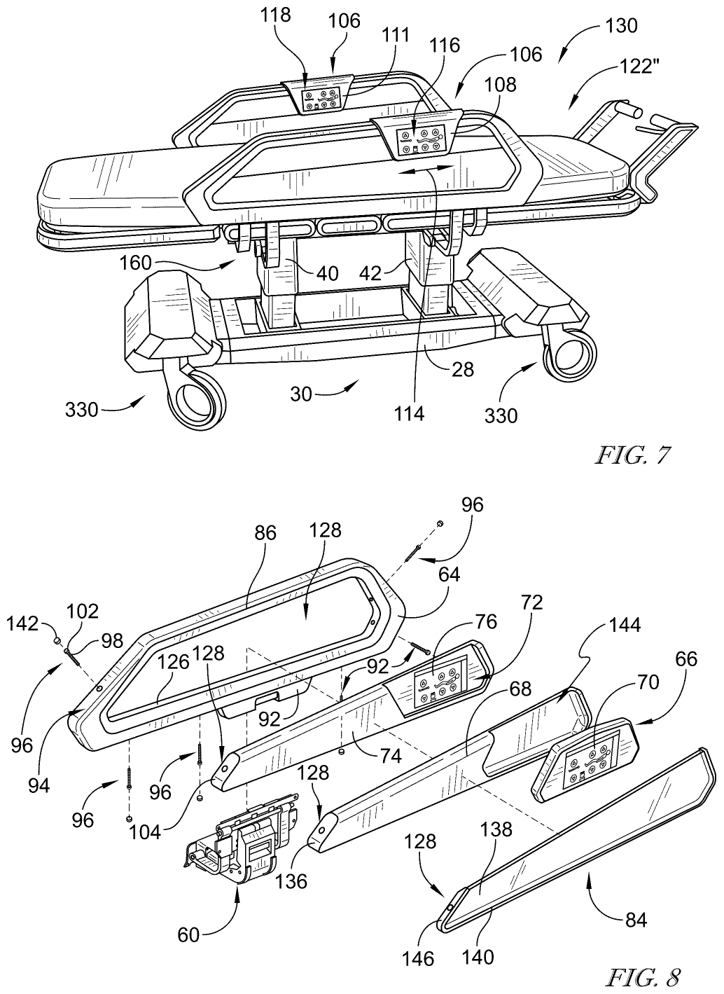

In the embodiment of FIG. 6, a stretcher 120 includes a side rail 122′ which has the side rail mechanism 160 and a fixed GUI insert 74 which supports a fixed GUI 72 as described above. In the embodiment of FIG. 7, a stretcher 130 includes a side rail 122″ that includes the side rail mechanism 160 supporting a barrier frame 64, which supports an insert 84. However, the side rail 122″ utilizes a saddle type user interface 106. The saddle type user interface 106 includes a first side 108 which is positioned to be accessed by a caregiver and a second side 111 which is positioned to be accessed by an occupant of the stretcher 130. The saddle type user interface 106 snaps onto an upper rail 112 of the barrier frame 64 and is movable along the rail to a number of positions as indicated by the arrow 114. It is contemplated that a user panel 116 on the caregiver side 108 may have different functionality compared to a user panel 118 positioned on the second/occupant side 111 of the user interface 106. The saddle type user interface 106 of the embodiment of FIG. 7 communicates with a control system of the stretcher 130 via a wireless connection, such as Bluetooth.

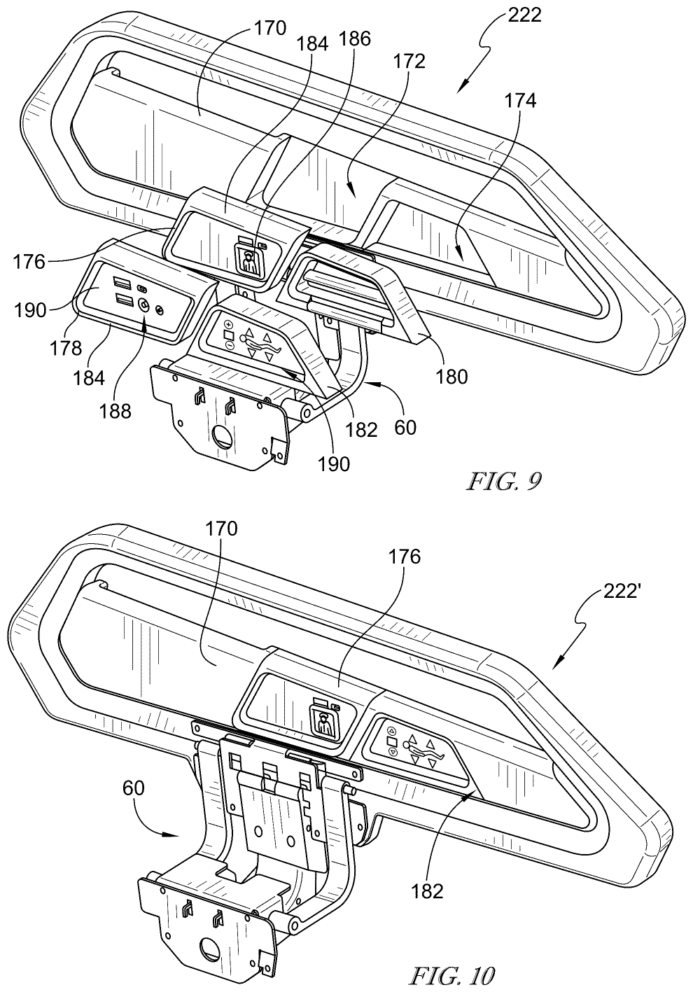

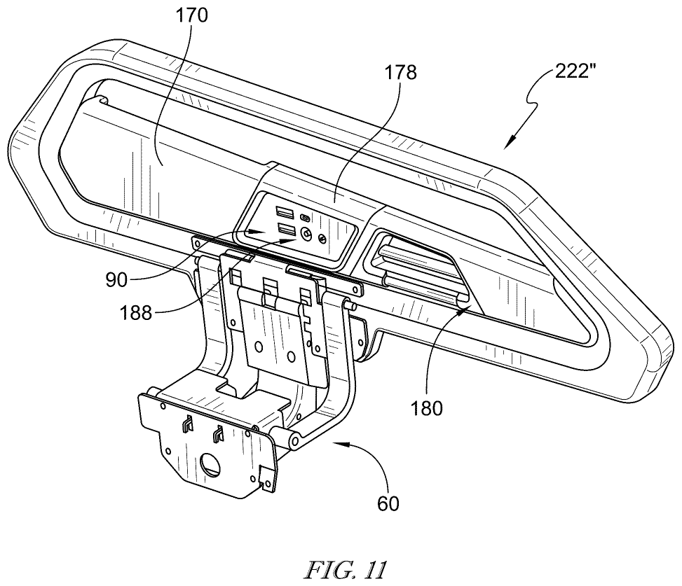

Referring now to FIG. 8, the modular nature of the side rails 22, 22, 22, 22 is illustrated by showing the interchangeable components of the siderails 22, 22, 22, 22. The barrier frame 64 includes an outer rail 86 which defines an inner opening 88. The barrier frame includes a mount 92 secured to the side rail mechanism 60 as suggested by FIG. 8. The rail 86 is formed to include several through holes similar to through-hole 94 shown in FIG. 8. Each through-hole 94 is formed with a countersink such that a fastener 96 can be inserted into the through-hole 94 with a threaded portion 98 extending through the rail 86 and a head 102 engages the countersink to limit travel of the fastener 96. Referring to the fixed GUI insert 74 as an example, the fixed GUI insert 74 is positioned such that a surface 104 engages a surface 126 of the barrier frame 64. The threaded portion 98 of the fastener 96 is then threaded into a threaded opening 128 on the fixed GUI insert 74. This causes the fixed GUI insert 74 to be secured to the barrier frame 64. It should be understood that each of the fasteners 96 are inserted through their respective through-holes 94 and into threaded openings similar to the threaded opening 128. Once each of the fasteners 96 is positioned in the barrier frame 64, a respective cap 142 is positioned in an outer surface 134 of the rail 86 and overlies the head 102 of the fastener 96 to provide a smooth surface along the surface 134.

Referring now to the removable GUI pod insert 68 shown in FIG. 8, a surface 136 is similar to the surface 104 of the fixed GUI insert 74. A threaded opening 128 is also formed in the removable GUI pod insert 68 and the removable GUI pod insert 68 can be secured to the rail 86 of the barrier frame 64 in a manner similar to that described above with regard to the fixed GUI insert 74. As shown in FIG. 8, the removable GUI pod insert 68 is formed to include a cavity 144 which is sized to receive the removable GUI pod 66 and has an interference fit which allows the removable GUI pod 66 to be securely positioned within the cavity 144 when it is positioned in the cavity 144.

Also shown in FIG. 8 is the opaque insert 84 which includes an opaque panel 138 and a trim rail 140 that wraps about a portion of the opaque panel 138. The trim rail 140 has a surface 146 which is formed to include a number of threaded openings 128. The fasteners 96 are used to secure the opaque insert 84 to the barrier frame 64 as described above. In this way, a user may easily configure a particular side rail utilizing the construction of the barrier frame 64 along with either the mechanism 60 or the mechanism 160. The siderails 22, 22′, 22″, 22′″ are modular in that the side rail mechanisms 60, 160 and the inserts 68, 74, and 84 are each interchangeable to change the structure of the particular side rail to fit the use case associated with the particular stretcher that is being configured. This provides significant flexibility for the user to structure a stretcher as required for a particular use case.

In another embodiment shown in FIG. 9, a modular side rail 222 includes an insert 170 which is similar to either the fixed GUI insert 74, or the removable GUI pod insert 68. Either of those inserts 68, 74 may be adapted to include the additional structures described herein with regard to the insert 170. The insert 170 has two separate cavities 172 and 174, each of which may receive one of multiple modules. The cavity 172 is adapted to receive either a nurse call module 176 or a sensor module 178. The modules each have a body 184 which is sized to be received into the cavity 172 and may be secured there with a friction fit or a snap fit. Because the cavities 172, 174 are positioned on an inboard side of the side rail 222, the modules 176, 178 are positioned to face the patient and provide functionality to the patient or associated with the patient. The module 176 includes a nurse call function that may be activated by pressing a nurse call button 186 which sends a nurse call signal to a remote location to draw attention to the patient as is known in the art. The sensing module 178 includes connector interfaces 188 which may be connected to sensors for sensing various vital signs of the patient including, for example, heart rate, respiratory rate, blood oxygen level (SpO₂), non-invasive blood pressure (NIBP), or other similar measurements. In the embodiment of the module 178, the module includes USB outlets 192 which may be used by a patient to charge a phone, but which may also be used as a universal interface for connecting with other equipment associated with the patient. Because the side rail 22 is configured to be positioned on the patient's left, a mirror image side rail of the side rail 222 can be positioned on the patient's right with one side having the module 176 and the other side having the module 178. Similarly, the same module 176 or 178 can be positioned on both sides to increase the availability of the particular functionality of the module 176 or 178.

The cavity 174 is adapted to receive either the module 180 where the module 182 in a manner similar to that described with regard to the modules 176 and 178. The module 180 is configured as a lateral trance for pass-through module which may be used to engage lateral transfer equipment to help with transferring a patient onto or off of the patient support apparatus associated with the side rail 222. The module 182 is a patient interface that includes a user panel 190. The user panel 190 is configured to allow the patient to adjust the position of the thigh deck section 54 or foot deck section 52 as well as adjusting entertainment functions such as television, radio, or the like.

Referring now to FIG. 10, a side rail 222′ is configured for typical patient usage with the module 176 positioned in the cavity 172 and the module 182 positioned in the cavity 174. In another embodiment shown in FIG. 11, a side rail 222″ includes the module 178 positioned in the cavity 172 and the module 180 positioned in the cavity 174. FIGS. 10-11 show the modularity of the side rail 222 and the ability to add taps the inboard side of a side rail to the particular needs of the patient supported on a particular patient support apparatus. It is contemplated that the modules 176, 178, 180, 182 are interchangeable and the cavities 172, 174 are configured to engage with the appropriate functionality when the particular module is positioned in the particular cavity. In some embodiments, each module and cavity may have respective contact connectors which engage with each other to provide electrical connections between the module 176, 178, 182 and a control system of the patient support apparatus. In some embodiments, the modules 176, 178, 182 may communicate with the control system of the patient support apparatus wirelessly and receive wireless power, such as inductive power, without requiring a physical connection between contacts of connectors.

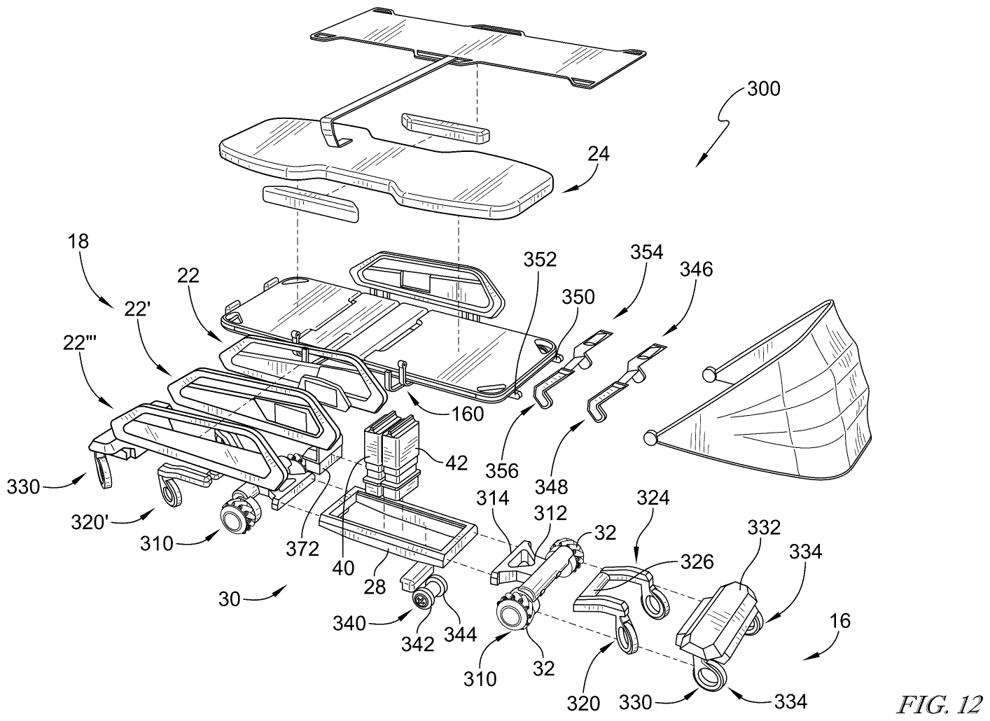

While the adaptability of the structure of the side rail for a particular use case has been described, additional flexibility and modularity is provided in the structure of the lower frame 30. While the particular lower frame 30 has one structure, as was described herein, a lower frame may be adapted to specific purposes using modular structures. Referring now to FIG. 12, the overall modularity of a stretcher system 300 is illustrated. Modularity is facilitated by the lower frame 30 which is configured to receive the lift columns 40, 42 in multiples positions. The main portion 28 of the lower frame 30 may be positioned on any one of multiple caster modules including a caster module 310 which utilizes the casters 32 described above. The caster module includes a frame 312 which includes a coupler. The coupler 314 can be secured to either end of the main portion 28 of the lower frame 30 with fasteners (not shown). 314. As suggested by FIG. 12, the caster module 310 is configured such that one module 310 can be coupled at the head end 16 of the main portion 28 of the lower frame 30 and another at the foot end 18 of the main portion 28 of the lower frame 30. The caster module 310 includes the motorized wheels/casters 32 which is suited for a high-end acuity situation or even a surgical support as will be described in further detail below.

Another caster module 320 includes casters 322 which are unpowered and support a frame 324 having a coupler 326 which is configured to be coupled to the main portion 28 of the lower frame 30 in a manner described above with regard to the caster module 310. The caster module 322 has an open space 328 between the casters 322 which facilitates the nesting of adjacent stretchers for storage and other functionality as will be described below. This standard caster module 320 is adapted for standards stretcher uses, such as procedural or emergency room use. In some embodiments, each of the casters 322 may be individually braked. Additionally one or more of the casters 322 may be configured to operate in a trailing configuration with no swivel to facilitate steering when the stretcher is pushed along the floor by a user.

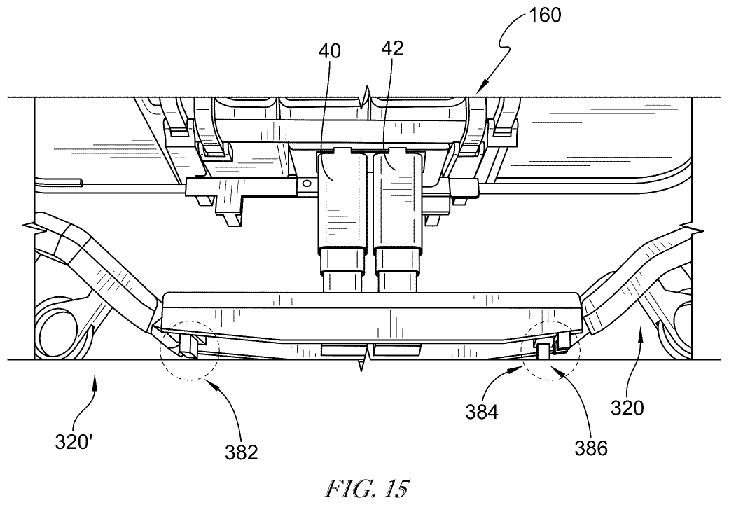

Referring now to FIG. 15, the caster module 320 is shown secured to a main portion 28 of the lower frame 30. In this embodiment, the caster module 320 cooperates with a similar caster module 320′ which is similar to the caster module 330 but the casters 322 are spaced farther apart in the caster module 330′ such that the caster module 330 nests within the caster module 330′ as shown in FIG. 15. When the caster modules 330, 330′ are used in a procedural configuration, the module 330′ includes an electrically actuated leg 382 and the module 330 includes a pair of electrically actuated legs 384, 386. Each of the legs 382, 384, 386 are extendable to contact the floor when the stretcher is being used for procedures. The legs 382, 384, 386 provide three points of contact so that the stretcher is positioned stably on the surface of a floor. The three points of contact is superior to four points of contact which may be unstable on an uneven floor. The legs 382, 384, and 386 are similar to the legs 158″ shown in U.S. Pat. No. 9,968,503 issued May 15, 2018, titled “DUAL COLUMN SURGICAL TABLE HAVING A SINGLE-HANDLE UNLOCK FOR TABLE ROTATION,” which is incorporated by reference for the disclosure of extendable legs for braking a patient support apparatus.

Still another caster module 330 is similar to the caster module 320 but includes a cover 332 to improve the aesthetics of the stretcher when the caster module 330 is present. The caster module 330 includes casters 334 which support a frame 336 which has a coupler 338 which allows the caster module 330 to be secured to the main portion 28 of the lower frame 30 in a manner similar to the caster module 310 discussed above. The casters 334 are unpowered and may be configured so that they are maintained in a trailing configuration to improve steer ability of the stretcher as a user pushes it over the floor.

The stretcher system 300 also includes a module or drive wheel configuration 340 which may be positioned in the main portion 28 of the lower frame 30. The drive will module includes two independently driven wheels 342, 344 which operate independently and based on user inputs from a user applied to a pair of handles 346 and 348 which include force sensors 422, 424 that provide a force input on each handle so that the force applied to each handle provides an input which controls the speed of the respective drive wheels 342, 344. In some embodiments, each wheel 342, 344 is independently responsive to a respective handle 348, 346. In some embodiments, the input signals of the handles 346, 348 are resolved and drive both of the wheels 342, 344 in unison, rather than independently. The handles 346, 348 mount on respective arms 350, 352 which are part of the upper frame 50.

A separate set of handles 354 356 may be mounted to the arms 350, 352. The handles 354, 356 lack any force sensors and simply provide handles to be acted upon by a user to manually move a stretcher over the floor, such as when the power will module 340 is omitted and either the caster module 320 or caster module 330 are used. It should also be understood that the handles 346, 348 may be used provide inputs to drive the powered casters 32 of the caster module 310. As such, the powered wheel module 340 would be omitted any time the caster module 310 is used. In this way, the stretcher system 300 allows for adaptability of a base system 360 to be configured in any of a number of ways to provide a method for moving the stretcher over the floor. Either of the sets of handles 346, 348 or 354, 356 may be moved between a stowed position such as that shown in FIGS. 1-4 and a use position such as that shown in FIGS. 5-6.

The lift columns 40, 42 are positionable in multiple locations along the length of the main portion 28 of the lower frame 30. For example, the columns 40, 42 may be positioned adjacent one another at a head end 16 of the main portion 28 of the lower frame 30 as shown in FIGS. 1-5. In other embodiments, the lift columns 40, 42 may be positioned adjacent one another and centered along the length of the main portion 28 of the lower frame 30 as shown in FIG. 6. In still other embodiments, the lift columns 40, 42 may be positioned spaced apart from each other with lift column 40 push positioned near a foot end 18 of the main portion 28 of the lower frame 30 and the lift column 42 positioned near a head end 16 of the main portion 28 of the lower frame 30. The main portion 28 of the lower frame 30 and the upper frame 50 accommodate these various positions to adapt the lift columns 40, 42 for particular use conditions. For example the embodiment of FIGS. 1-5 provides extensive clearance under the seat and thigh areas of the patient which may be useful for example in utilizing AC-arm for x-raying a patient positioned on the particular stretcher. The spaced apart configuration of the lift columns 40, 40 to provide improved stability of the upper frame 50 which increases the capacity of the particular stretcher and reduces the potential movement of the stretcher during procedures, for example.

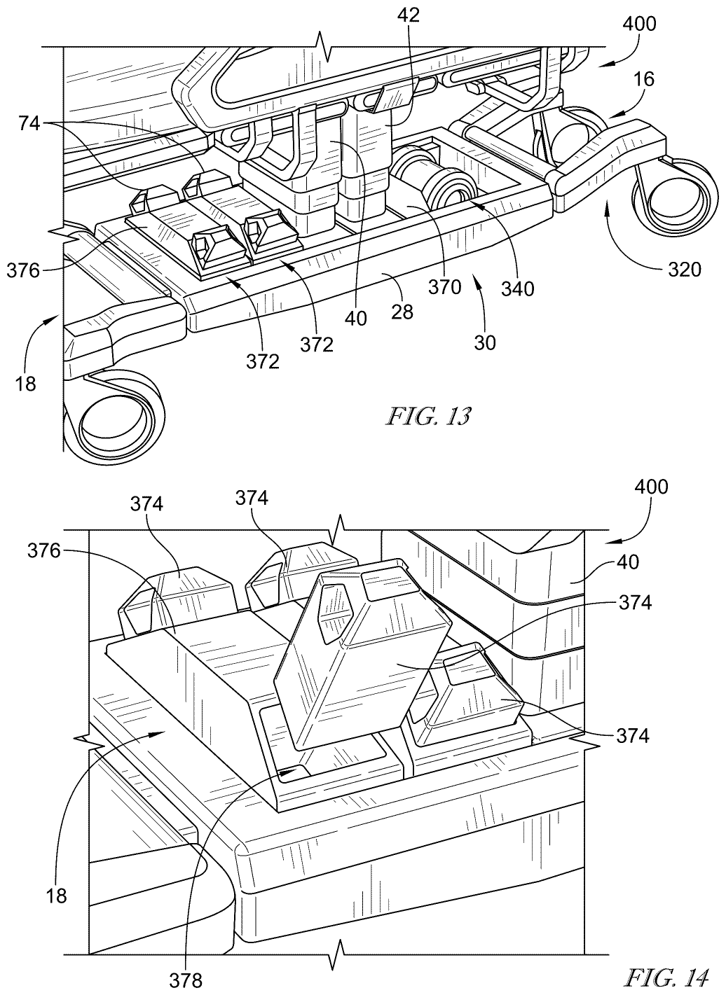

Referring now to FIG. 13, an enlarged view of a particular embodiment of a stretcher 400 shows the main portion 28 of the lower frame 30 with several components positioned therein. The lift columns 40, 42 are positioned centrally with a drive will module 340 positioned near a head end 16 of the main portion 28 of the lower frame 30. The main portion 28 of the lower frame 30 also supports a control module 370 and a pair of power modules 372, 372. The operation of the powered wheel module 340 and the lift columns 40, 42 have been described above. The control module 370 houses the controller 414 for the stretcher 400 and is operable to communicate with the various electrical components of the control system of the stretcher 400. The control module 370 in the illustrative embodiment of stretcher 400 of FIG. 13 communicates wirelessly with various components of the stretcher 400, including any user interfaces, the lift columns 40, 42, the force sensors of the handles 346, 348, the powered wheel module 340, and the power modules 372, 372.

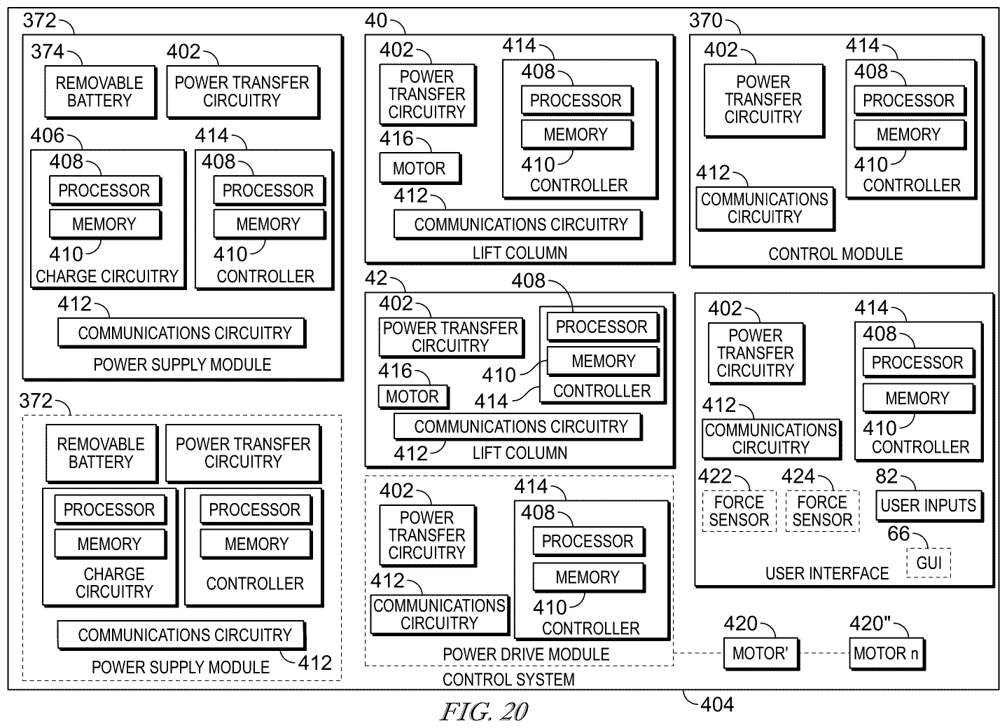

The power modules 372, 372 include batteries 374 as suggested by the enlarged view of FIG. 14. Each control module housing 376 encloses circuitry that manages the operation of the batteries and the transfer of power to the other components of the control system of the stretcher 400 as described below with reference to FIG. 20. Each battery 374 is received in a slot 378. The batteries 374 are rechargeable on the stretcher 400 through inductive charging, but may also be removed and replaced in an emergent situation where inductive charging is not available and power is needed immediately. One approach to inductive charging suitable for charging the batteries 374 is the inductive power and charging system disclosed in U.S. Pat. No. 10,938,446, issued on Mar. 2, 2021, and titled “WIRELESS BED POWER,” which is incorporated herein by reference for the disclosure of a system for inductive charging and wireless power and data transfer in a patient support apparatus.

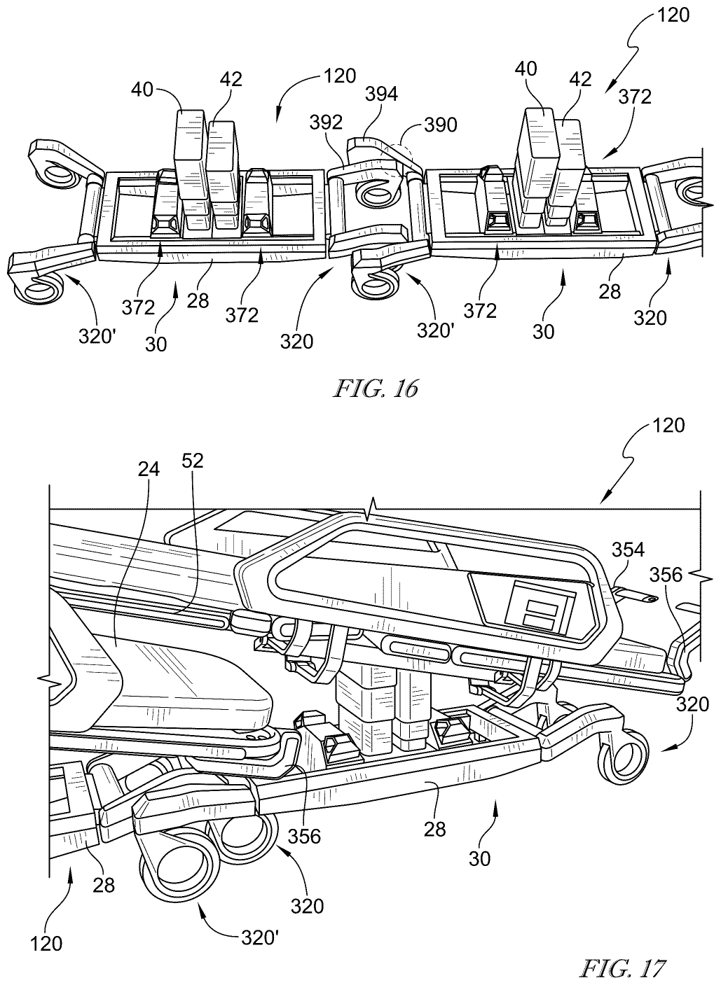

Referring now to FIG. 16, two adjacent stretchers 120, 120 are positioned with the caster module 330 of the first of the two stretchers 120, 120 positioned in a nested configuration between the casters of a caster module 330′ of the second of the two stretchers 120. In this configuration, an area shown in the circle as indicated by reference 390 has portions of each of the caster modules 330, 330′ in very close proximity such that an inductive charge can be transferred between the frame members 392, 394 allowing power to transfer between the two stretchers 120, 120 so that a charge can be transferred between their respective power modules 372.

Referring now to FIG. 17, the two stretchers 120, 120 are shown in detail with their respective articulated decks 26, 26 position in a tilted configuration with the lift column 42 lowered as compared to the lift column 40 in each stretcher 120 so that the articulated decks 26, 26 have clearance there between two allow the stretchers to become close in proximity and accomplish the nesting of the caster modules 330, 330′. When the respective stretchers 100 2120 are configured to be nested, the articulated deck 26 is arranged in a flat configuration with the head end 16 of each of the stretchers 120, 120 lowered so that the foot end 18 is raised. The respective head end 16 of the stretcher 120 illustrated on the left of FIG. 17 is positioned such that the head deck section 58 is positioned below the foot deck section 52 of the stretcher 120 positioned in the right of FIG. 17. It should also be noted that the push handles 354, 356 of the stretcher 120 positioned on the left in FIG. 17 are placed in a stowed position to provide clearance between the patient supporting surface 24 of the stretcher 120 positioned on the left and the foot deck section 52 of the stretcher 120 positioned on the right.

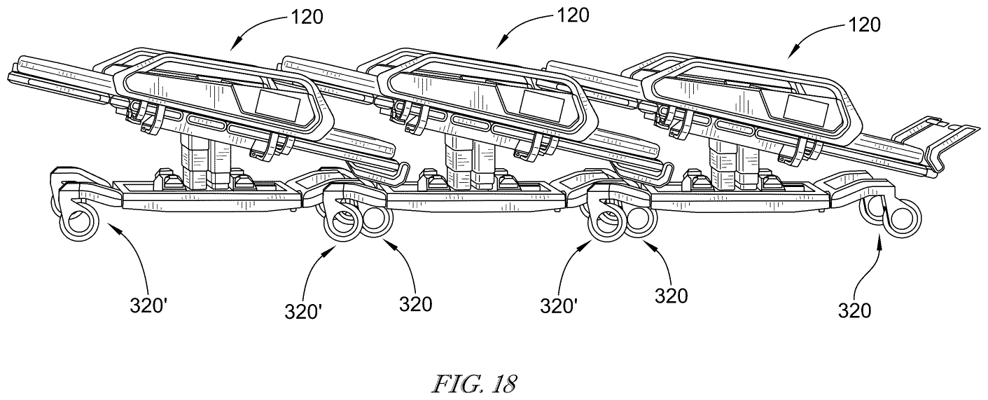

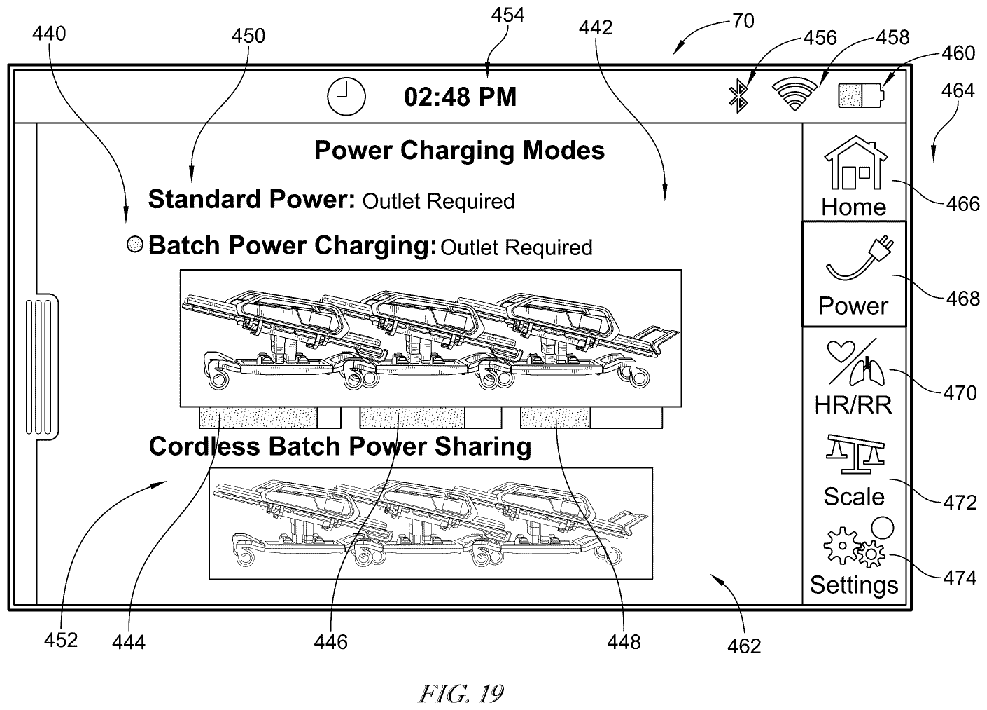

Referring now to FIG. 18, it can be seen that multiple stretchers 120 may be positioned in a nested configuration. FIG. 18 illustrates how the nested stretchers take up less space than would be required if each of the stretcher's were positioned without nesting. This nesting approach allows for improved storage, but also provides for the ability of multiple stretchers 120 to be simultaneously charged. This allows for nesting of the bases thus reducing the overall storage footprint of the stretchers 120, 120. 120. When bases are nested, the stretchers 120, 120, 120 can begin to batch charge the batteries 374. The group of stretchers 120, 120, 120 share power charging with only one stretcher 120 plugged into an outlet. The stretcher GUIs allow for setting specific charge levels for each batched stretcher 120 as suggested in FIG. 19. A variety of modes, including adjusting percentages of each stretcher 120, 120, 120 charging simultaneously, charging one at a time, setting minimum charge levels before batch charging the next stretcher in line are all options that may be selected. The batch charging feature is also available while all of the stretchers 120, 120, 120 are unplugged as well. The shared charging may draw a charge from one of the stretchers 120 that has more than a minimally acceptable charge level to transfer the charge to another stretcher 120 has less than a minimally acceptable charge. In this way, all of the stretchers 120, 120, 120 may be prepared for use if an inrush of patients requiring stretchers is experienced by a facility.

Referring now to FIG. 20, details of an embodiment of a control system 404 for the stretchers disclosed herein is shown to provide a better understanding of the control scheme for the stretchers. The embodiment of FIG. 20 shows two different power supply modules 372, 372. One of the power modules 372 is shown in dotted lines indicating that the power module is optional depending on the needs of a particular embodiment. Each power module 372 includes power transfer circuitry 402 that is common to the various electrical components disclosed herein with each component having the respective power transfer circuitry 402. The power transfer circuitry 402 includes the circuitry necessary to transfer power inductively across multiple components. In some embodiments, the power transfer circuitry may be a simple hardwired connection between components. In some embodiments, some modules may utilize inductive power transfer while other modules utilize hardwired power transfer, depending on the particular architecture required for a particular application.

The power supply modules 372, 372 each also include charge circuitry 406 which includes a processor 408 and a memory device 410. The charge circuitry 406 is configured to control the charging of the removable battery 374 and to facilitate management of the charging of the power supply module 372 and the transfer of a charge from a particular power supply module 372 and other power supply modules 372 on the particular stretcher, or on adjacent stretchers which are nested with the given stretcher to transfer power there between as described above. The charge circuitry 406 is controlled by the processor 408 which utilizes instructions stored on the memory device 410 to control the operation of the charge circuitry 406

The power transfer circuitry 402 is also operable to transfer power between adjacent stretchers as described above. The power supply modules 372, 372 also each include communications circuitry 412 that provides for communications amongst the various electrical components on a particular stretcher. In the illustrative embodiment, the communication circuitry is configured to provide wireless communications using a low-power wireless communications protocol, such as Bluetooth®, for example. In other embodiments, the communications circuitry 412 may employ the RS-485 communications protocol over a twisted-pair bus. It should be understood that any of a number of communications protocols known in the art may be used for the communications circuitry 412, including, but not limited to, Echelon, CAN, SPI, USB, and LIN or another suitable electronic communications protocol. In still other embodiments, the communications may include circuitry that allows for a hardwired connection using an IEEE 802.3 connection, an RS-232 compliant connection, an RS-483 compliant connection, or other protocols known in the art including other wireless protocols. For example, communications circuitry 412 may use of any one or more communication technologies (e.g., wired or wireless communications) and associated protocols (e.g., Ethernet, InfiniBand®, Wi-Fi®, WiMAX, 3G, 4G LTE, 5G, etc.) to effect communications. The communications circuitry 412 operates under the control of the controller 414 of the power supply module 372 each power supply module 372 includes a controller which has a processor 408 and a memory device 410 which includes instructions that, when executed by the processor, cause the controller to control the operation of the power transfer circuitry 402, the communication circuitry 412, and the charge circuitry 406.

Each of the lift columns 40 and 42 also include a controller 414, communications circuitry 412, and power transfer circuitry 402. Each lift column 40, 42 also includes a motor 416. The controllers 414 of the lift columns 40, 42 control the operation of the motor 416 based on inputs from a user. In the present embodiment, the motor 416 includes an onboard motor controller which, under the control of the controller 414, manages the power and position of the motor 416 to define the position of each respective lift column 40 or 42.

The power drive module 340 includes a controller 414, communication circuitry 412, and a power transfer circuitry 402. The controller 414 of the power drive module 340 is operable to control the operation of one or more motors 420¹-420ⁿ. It should be understood that the power drive module 340 may include integrated motors as suggested by FIG. 12, or may operate the motors of the four casters 32 described above. The power drive module 340 is illustrated in dotted line in FIG. 22 indicate that it is an optional component.

In the embodiment of FIG. 20, the GUI pod 66 includes a controller 414, communication circuitry 412, and power transfer circuitry 402. The GUI pod also includes the touchscreen 70 and the user interface 82. It should be understood that the user interface 426 is but one a unit of many variations of user-interface structures which may be utilized on a given stretcher. As described above, various user interfaces that include user input panels and modules may be utilized on a given stretcher in many different ways. The structure of the user interface 426 disclosed herein is provided to suggest one of many different variations that are potentially available.

The control system 404 also includes the control module 372. The control module also includes a controller 414, communication circuitry 412, and power transfer circuitry 402. The control module 370 provides the central logic for the operation of the control system 404. For example, the control module utilizes information from the controller 414 of the user interface 426 to signal the controller 414 of the lift columns 40, 42 as to the operation of the motor 416. While each of the subsystems of the control system 404 are able to perform their dedicated functions autonomously, the control module 370 provides the centralized logic necessary to operate the entire control system. For example, the control module 370 may control the priority of certain communications to assure that system critical can medications take precedence over optional communications over the control system 404. Thus, while each of the electronic components has its own controller 414 with a dedicated processor 408 and memory device 410, the central logic is managed by the control module 370.

It is contemplated by the present disclosure that the processors 408 may be embodied as, or otherwise be included in, without limitation, an embedded computing system, a System-on-a-Chip (SoC), a multiprocessor system, a processor-based system, a microcontroller, an application specific integrated circuit (ASIC), a field programmable gate array (FPGA), and/or any other similar computing device. The present disclosure also contemplates that memory 410 may be embodied as one or more of volatile memory, non-volatile memory, random access memory (RAM), read only memory (ROM), a media disk, magnetic disk, optical storage, flash memory devices, and other similar devices capable of storing software for controlling functions. The memory 410 may be an independent device or integrated with any device serving as a processor 408.

Referring again now to FIG. 19, the touchscreen 70 is shown displaying a status of the charging of multiple stretchers 120. As shown on the touchscreen 70, batch power charging has been selected as indicated by an active radio button 440. As indicated at 442, an outlet is required to accomplish this batch power charging which is providing charging to each of the nested stretchers 120. The level of charge for each of the stretchers 120 is shown by respective fuel gauge indicators 444, 446, 448. This provides a user with a quick reference for the level of charge of each of the stretcher's 120. As indicated at 450 a stretcher to be utilizing standard power wherein the stretcher is plugged into a standard outlet. In such a case, the mains power is provided to the power supply module 372 which utilizes the mains power to both charge the removable battery and provide ongoing power to the remainder of the control system 404. Once mains power is disconnected, by unplugging an outlet cord, the particular stretcher 120 will operate on the power of the removable battery 374. As indicated at 452, a user may also select cordless batch power-sharing which will allow the nested stretchers 120, 120, 122 transfer power amongst the stretchers to achieve a balanced charge level as described above. This touchscreen 70 provides additional information to user including the time at 454, whether Bluetooth connections are established at 456, and whether Wi-Fi connections are established at 458. A battery charge level indicator at 460 provides the user with a clear understanding of the level of charge of the particular stretcher associated with the touchscreen 70. The touchscreen is separated into two portions including an information portion 462 which provides an interactive screen for particular functions to be managed by a user. A menu bar 464 positioned at the right side of the touchscreen 70 allows a user to choose between a home screen icon 466 which will cause the information portion to display a home screen, the powered screen displayed in FIG. 19 by selecting a power icon 468 a vital signs monitoring screen by actuating an icon 470, a scale system operation screen at 472 or a settings screen at icon 474. Other functionality may also be available at the menu bar 464 by scrolling the menu bar icons up or down.

Although this disclosure refers to specific embodiments, it will be understood by those skilled in the art that various changes in form and detail may be made without departing from the subject matter set forth in the accompanying claims. For example, the disclosure has been illustrated and described in detail in the drawings and the foregoing description, such illustration and description are to be considered illustrative or exemplary and not restrictive. The disclosure is not limited to the disclosed embodiments. From reading the present disclosure, other modifications will be apparent to a person skilled in the art. Such modifications may involve other features, which are already known in the art and may be used instead of or in addition to features already described herein. In the claims, the word “comprising” does not exclude other elements or steps, and the indefinite article “a” or “an” does not exclude a plurality.

1. A patient support apparatus comprising
a lower frame including a main portion, a first castor module positioned at a head end of the main portion, and a second castor module positioned at a foot end of the main portion,
a power module positionable in multiple positions on the main portion, the power module including a rechargeable battery,
a control system including a controller having a processor and a memory, the memory including instructions executable by the processor,
a user interface including a touchscreen, the user interface operable to display information regarding the charge in the rechargeable battery of the power module, and to receive inputs from a user,
wherein the controller is operable to receive information regarding the charge in a patient support apparatus adjacent the patient support apparatus of the controller, display information regarding the charge of batteries of the adjacent patient support apparatus, and to, based on inputs from a user, transfer a charge from the power module of the patient support apparatus to the batteries of an adjacent patient support apparatus.

2. The patient support apparatus of claim 1, wherein the first castor module of the patient support apparatus is configured to nest with a second castor module of an adjacent patient support apparatus.

3. The patient support apparatus of claim 2, wherein the first castor module of the patient support apparatus includes an inductive coupler operable to transfer power between an inductive coupler with the second castor module of the adjacent patient support apparatus under the control of the controller.

4. The patient support apparatus of claim 3, wherein the patient support apparatus includes a plurality of power modules positioned on the main portion of the lower frame.

5. The patient support apparatus of claim 4, wherein the controller of the patient support apparatus is operable to detect a plurality of adjacent patient support apparatuses, communicate with the adjacent patient support apparatuses to determine a level of charge in their respective power modules, and to display the respective charges of each of the patient support apparatuses power modules on the user interface.

6. The patient support apparatus of claim 5, wherein the controller of the patient support apparatus is operable to transfer power between the adjacent patient support apparatuses to charge the respective power modules of each of the adjacent patient support apparatuses.

7. The patient support apparatus of claim 6, wherein the controller of the patient support apparatus is operable to transfer power between the adjacent patient support apparatuses when at least one of the patient support apparatuses is connected to an outlet.

8. The patient support apparatus of claim 6, wherein the controller of the patient support apparatus is operable to transfer power between the adjacent patient support apparatuses when none of the adjacent patient support apparatuses is connected to an outlet.

9. The patient support apparatus of claim 1, wherein the controller communicates wirelessly between the user interface and the power module.

10. The patient support apparatus of claim 9, wherein the controller and the user interface are powered inductively by the power module.

11. The patient support apparatus of claim 10, wherein the patient support apparatus further comprises a lift column supported on the lower frame and an upper frame supported on the lift column, the lift column operable to move the upper frame relative to the lower frame, the lift column being powered inductively by the power module.

12. The patient support apparatus of claim 11, wherein the controller communicates wirelessly with the lift column, the controller receiving inputs from the user interface and controlling operation of the lift column based on the inputs from the user interface.

13. A method of charging a system of patient support apparatuses, the method comprising
positioning a first and a second patient support apparatus adjacent one another,
establishing communication between the first and second patient support apparatus,
detecting the respective charge levels of the adjacent patient support apparatuses, and
utilizing a control system of the first patient support apparatus to control the operation of power modules on each the first and second patient support apparatuses to transfer a charge between the power modules of each of the first and second patient support apparatuses to achieve an acceptable charge level in each of the first and second patient support apparatuses.

14. The method of claim 13, further comprising connecting at least one of the first and second patient support apparatuses to an outlet to receive power from the outlet, the power from the outlet being used to charge both the first and second patient support apparatuses.

15. The method of claim 13, further comprising transferring the charge between the power modules of the first and second patient support apparatuses when the first and second apparatuses are not connected to an external source of power.

16. The method of claim 13, further comprising positioning a third patient support apparatus adjacent at least one of the first and second patient support apparatuses, and wherein the detecting the respective charge levels of the adjacent patient support apparatuses includes detecting the respective charge levels of the first, second, and third patient support apparatuses.

17. The method of claim 16, further comprising transferring a charge between the power modules of each of the first, second, and third patient support apparatuses to achieve an acceptable charge level in each of the first, second, and third patient support apparatuses.

18. The method of claim 17, further comprising connecting at least one of the first, second, and third patient support apparatuses to an outlet to receive power from the outlet, the power from the outlet being used to charge the first, second, and third patient support apparatuses.

19. The method of claim 17, further comprising transferring the charge between the power modules of the first, second, and third patient support apparatuses when the first, second, and third apparatuses are not connected to an external source of power.
